(19) United States
(12) Patent Application Publication
(10) Pub. No.: US 2003/0038831 A1
(43) Pub. Date: Feb. 27, 2003

(54) Timeline display apparatus

(75) Inventor: Arnoud P. Engelfriet, Eindhoven (NL)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/210,843

(22) Filed: Jul. 31, 2002

(30) Foreign Application Priority Data
Aug. 22, 2001 (EP) 01203162.1

(51) Int. Cl. G09G 5/00

(52) U.S. Cl. 345/719

(57) ABSTRACT

The present invention provides a timeline display apparatus having a processor (240), a memory (250), a graphics engine (230) and a display (120). The apparatus is arranged to display a timeline (1) divided into interval representations corresponding to temporal intervals (2, 3, 4, 5, 6, 7, 8, 9, 10, 11, 12, 13). The display area accorded to each interval representation (2, 3, 4, 5, 6, 7, 8, 9, 10, 11, 12 13) is dependent upon the proximity of the interval representation (2, 3, 4, 5, 6, 7, 8, 9, 10, 11, 12, 13) to a given point in time (14). The apparatus of the present invention thus addresses difficulties relating to the display of information encountered by prior art apparatus and allows a more detailed view to be made of particular points on a timeline which are of interest.

The present invention relates to timeline display apparatus, a computer program product for creating a timeline and a method of displaying temporal information. Particularly, though not exclusively, the invention relates to a hand held electronic apparatus which can display a timeline.

Electronic apparatus, such as hand-held personal information managers, palmtop computers and personal computers with specific software, is well known. Such apparatus is frequently able to display a timeline on a screen to provide an overview of events entered into a diary. The timeline is a bar which is usually arranged to extend horizontally across the screen and can indicate the temporal relationship between events. The timeline is divided into regular intervals, each corresponding to a particular period of time, such as a day, a week or a month. Events can be indicated on the timeline at the corresponding points in time. The events can be indicated in various ways, for example by a bar extending between the start and end dates of an extended event, for example a project, or by an icon at the appropriate point in time.

Timelines are useful in calendaring and scheduling applications and in project planning, especially for apparatus having a small screen and consequently a limited display area. In the case of project planning, each task in a project can be indicated on the timeline and the indicators for each task can be positioned below one another on the screen, one line per task. Related tasks can be linked, so that it is obvious that one must start after another.

A user of such prior-art apparatus is able to gain an overview of upcoming events and the relationship between them. If two bands lay directly after one another then so too do the events and if they overlap, so do the events. The timeline can thus indicate scheduling problems as well as allowing a user to quickly determine available time periods and the time until events such as deadlines.

Prior-art devices, particularly hand held-devices, have a number of disadvantages. In particular as they have a limited display area, the length of time which can be shown is limited if the events are to be indicated clearly. Alternatively, if a longer period of time is displayed then it may become almost impossible to distinguish events from one another or establish exactly when they occur due to the limited display area accorded to each event. For example, a typical personal information manager has a screen with a 160×160 pixel display. A timeline divided into daily intervals can display 5 days each having a length of 32 pixels. To show an overview of an entire month, only a length of 5 pixels is available for each day and the amount of information that can be displayed is severely reduced.

The prior-art devices also accord the same display area to each regular interval of time on the timeline regardless of its importance to the user or the number of events occurring during that time period. Thus, a large proportion of available screen space is often wasted by showing large periods of free time or events that are too far in the future to be of significant importance to the user.

Attempts have been made to avoid such disadvantages. For example, it is known to provide apparatus with a calendar which shows a daily view and a weekly or monthly view at the same time, with important days in the monthly view marked. The user can view detailed information in the daily view and can see an overview of important upcoming events from the monthly view. This system also has disadvantages as it accords dates at the end of the month the same display area as the day proceeding that shown in the daily view. Thus if a number of important events are scheduled for an impending day, not all of them can be shown on such an overview.

It is also known to provide apparatus with timelines which are shown in a 3-dimensional view. The 3-dimensional perspective warps the presentation of the timeline so that faraway intervals appear smaller than impending intervals. However, such displays can be awkward to interpret, do not adequately solve the problems discussed and in effect waste a proportion of the display area.

The present invention aims to overcome at least one of the disadvantages associated with prior-art apparatus, whether discussed above or otherwise, by providing a timeline display apparatus which is arranged to display a novel timeline such that it optimises the use of display space.

According to an aspect of the invention, there is provided a timeline display apparatus comprising a processor, a memory, a graphics engine, and a display arranged to generate and display a timeline on which events can be displayed, wherein the timeline generated is divided into a plurality of interval representations corresponding to temporal intervals and characterized in that the display area allocated to at least one interval is dependent upon the temporal distance of that particular interval representation from a given point in time.

By ensuring that interval representations can have variable lengths dependent upon their distance from a particular point of time, a more efficient and flexible display is achieved.

In a preferred embodiment, the given point in time corresponds to the point in time at which the timeline is being displayed. The given point may correspond to a point of origin (the beginning) of the timeline, but in alternatives the given point may correspond to a time represented between start and end points of the timeline.

By providing for larger allocated display areas around the given point in time, a much more detailed display of information on the timeline is provided. In this way, time periods of interest are given visual priority over those of less interest.

Preferably, the apparatus is arranged in such a way that a number of interval representations adjacent to the interval representation containing the given point in time can be selected to have an identical amount of display area allocated to each of them, after which the display area accorded to less adjacent interval representations of the same type is reduced.

Different types of interval representation may be provided corresponding to different time intervals such as a day, week or month.

A user may select the point at which the display area allocated to interval representations is reduced.

Preferably, the apparatus is arranged to automatically select a point at which the display area allocated to a particular type of interval representation is to be reduced.

The timeline may be displayed in such a way that the given point in time lies at the end of the timeline and only the part of the interval containing the given point in time relating to points in time after said given point in time is displayed.

Alternatively, the timeline may be displayed in such a way that the whole of the interval containing the given point in time is displayed such that the given point in time lies in the interval at the start of the timeline such that it is at an end location of the timeline but not at the very end thereof.

In a further alternative, the timeline may be displayed in such a way that one or more intervals lie before the interval containing the given point in time such that said interval does not lie at the start of the timeline.

In another aspect of the invention, there is provided a computer program product for creating a timeline for an electronic device, wherein the product is arranged to generate a timeline for display on the electronic device and to divide the timeline into a plurality of interval representations corresponding to temporal intervals, and upon which timeline events can be displayed, the product being characterized in that the display area accorded to at least one interval representation is dependent upon its temporal distance from a given point in time.

In a still further aspect, there is provided a method of displaying temporal information, the method comprising the step of programming an electronic device to display a timeline divided into a plurality of interval representations corresponding to temporal intervals and characterized in that the electronic device is programmed such that the display area accorded to at least one interval representation is dependent upon its temporal distance from a given point in time.

For a better understanding of the invention, and to show how embodiments of the same may be carried into effect, reference will now be made, by way of example, to the accompanying diagrammatic drawings in which:

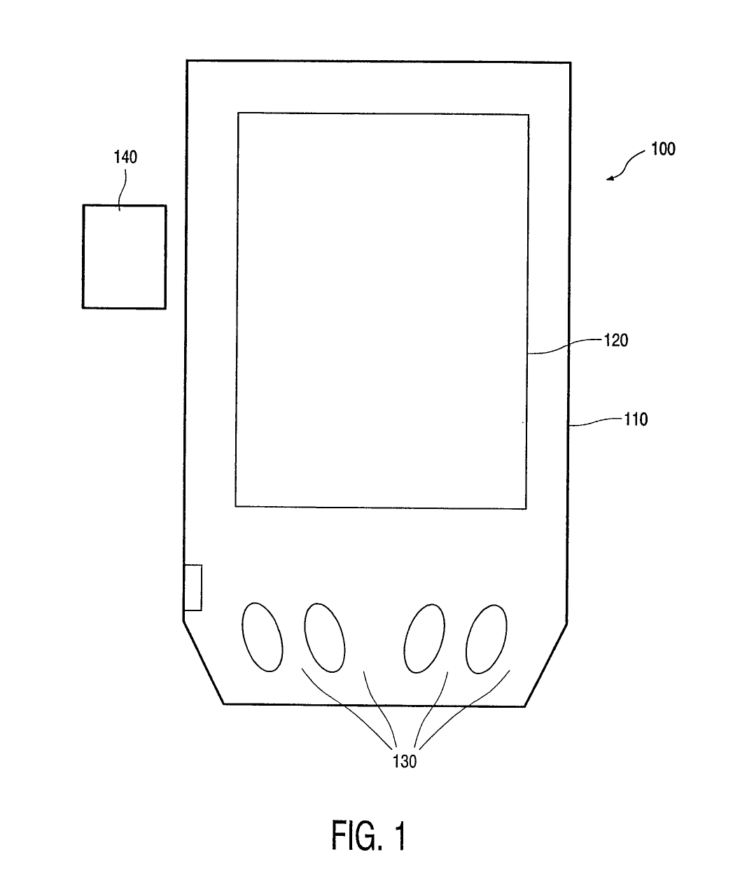

FIG. 1 shows a timeline display apparatus for implementing a timeline display in accordance with the invention;

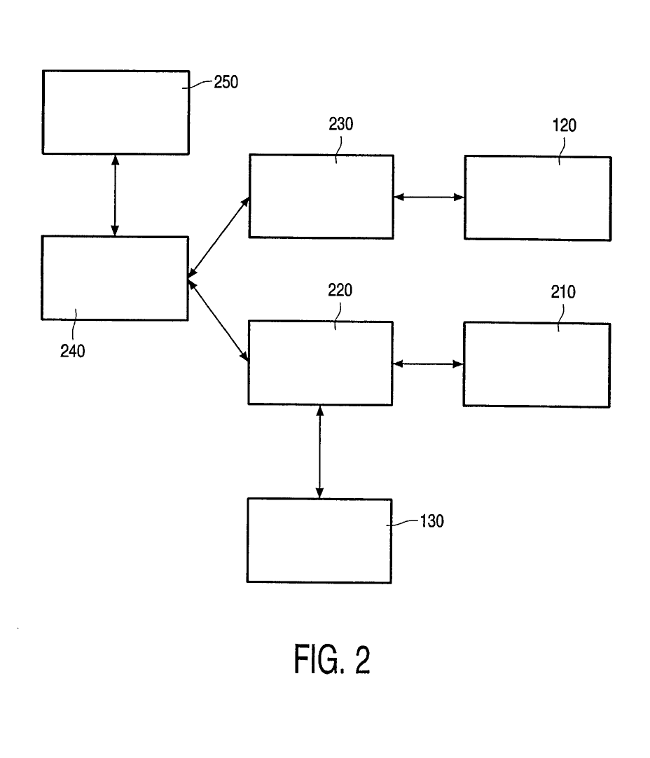

FIG. 2 is a schematic block diagram of the apparatus of FIG. 1;

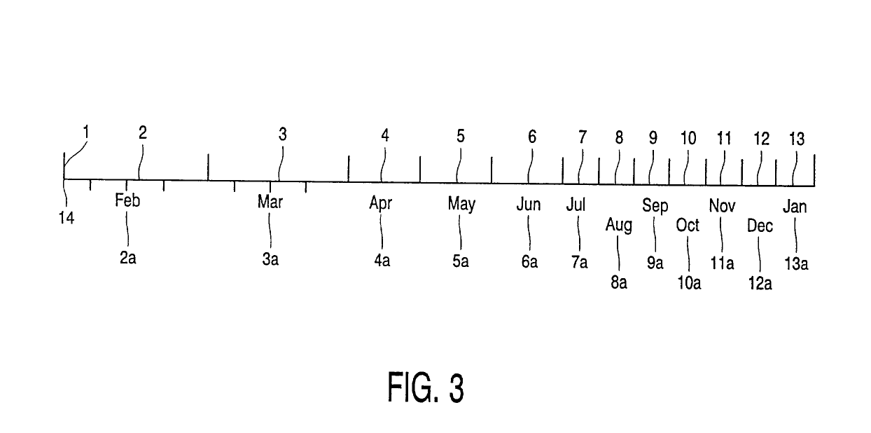

FIG. 3 shows a basic timeline display;

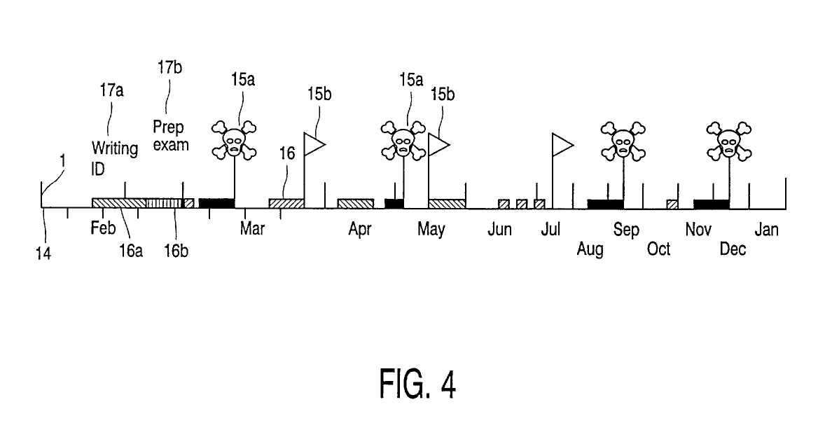

FIG. 4 shows the timeline display of FIG. 3 for a timeline display apparatus indicating important events; and

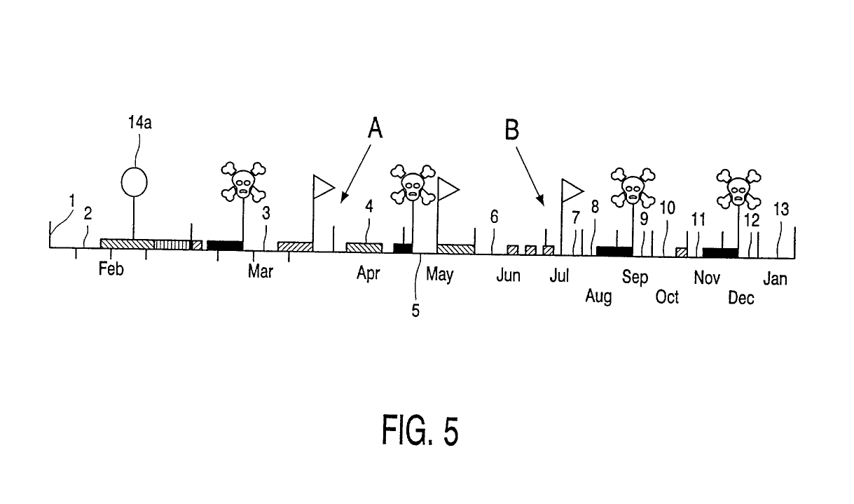

FIG. 5 shows an alternative format of a timeline display in accordance with the present invention.

Referring to FIG. 1, a timeline display apparatus 100 is shown. The apparatus 100 comprises a body 110, a display 120 and various input buttons 130. The input buttons 130 are used to input data from the user and the display may comprise a touch-sensitive screen arranged to enable a user to draw with a stylus (not shown) on the screen. There is also shown a data carrier 140 comprising a computer program product on, e.g., a disk and arranged to generate a timeline.

Referring now to FIG. 2, there is shown a schematic block diagram of components of the apparatus of FIG. 1.

The apparatus is shown as comprising the display 120, input buttons 130, a stylus input 210, an input interface 220, graphics engine 230, a timeline generator in the form of processor 240 and memory 250.

The apparatus of FIGS. 1 and 2, which may comprise a palm top computer for instance, may carry out a number of different functions.

For instance, the memory 250 (which typically may be a flash memory) stores a number of programs for implementing applications such as a diary, a telephone book, a note book, a planning tool, games etc. The program of the data carrier 140 may be loaded into the memory 250. Apart from performing timeline generation, the processor 240 is also arranged to execute the computer programs loaded in memory 250 and to perform other general control and processing functions. For instance, upon activation of a particular one of the input buttons 130 by a user, the diary application may be executed.

Graphics engine 230, which is coupled to the processor 240 and the display 120, is arranged to enable the drawing of pixels, lines, images, text and so on on the display 20 under the command of the user and in accordance with the particular application being executed. For instance, where a user is utilising a stylus 210 to draw a line on the screen, the input interface 220 interfaces with the stylus to register the user's desired intent and to translate pressure exerted by the user on a particular part of the screen 120 into a line drawn by the graphics engine 230 and displayed on the display 120.

If the user desires to use a planning tool application, for instance, then the user may activate that application by pressing one of the user input buttons by pressing a particular designated input button 130.

The planning tool application may comprise a number of modules, realized as software modules or objects. The planning tool application is arranged to maintain planning information on one or more projects, for instance by generating Gantt-charts or timelines.

An event processing software module receives user input related to events to be included in the plan. For instance, the user may input a task, give it a name, choose a deadline for a task and so on. The event processing module receives this information from input buttons 130, stylus 210 etc., or from any other suitable input device such as an attached keyboard (not shown) and stores it in memory 250—perhaps after preliminary processing such as input validation.

The information stored in the memory 250 may be used by various modules, such as a Gantt-chart module which generates a Gantt-chart for display to the user.

The timeline generator function is embodied in a timeline generation software module executed by the processor 240 and is arranged to thereafter organize the event dates and any associated event text and generate a graphical representation of a timeline comprising these events. This representation is then fed to the graphics engine 230 for display to the user on the display 120.

The input interface 220 is arranged to interpret user input from the stylus 210 and the input buttons 130 and feed this to the planning tool application to transfer input data to form events on the timeline.

Referring now to FIGS. 3 through 5, a timeline 1 generated by the apparatus 100 and manipulable by a user is shown.

The format of a timeline 1 in accordance with the present invention is best illustrated by FIG. 1. The timeline 1 is divided into representations of temporal intervals 2, 3, 4, 5, 6, 7, 8, 9, 10, 11, 12, 13 each corresponding to a period of one month. Each interval representation 2, 3, 4, 5, 6, 7, 8, 9, 10, 11, 12, 13 is provided with a label 2a, 3a, 4a, 5a, 6a, 7a, 8a, 9a, 10a, 11a, 12a, 13a, respectively, indicating the month to which each representation corresponds.

The timeline is arranged in such a way that interval representations closer to a given point in time 14 are accorded a larger display area. The given point in time can be the current date and this may be indicated on the timeline though it is not in FIG. 3. The month of February contains the given point in time 14 and the month of March immediately succeeds February so the interval representations 2, 3 corresponding to these months are each accorded the largest display area. The next representations 4, 5, 6 for April, May and June are each accorded a smaller display area. Similarly, the next interval representations 7, 8, 9, 10, 11, 12, 13 for July, August, September, October, November, December and January are each accorded a still smaller display area.

FIG. 4 shows a timeline 1 which has a format identical to that of FIG. 3 but displays events that are stored in the apparatus.

Each event is indicated by an icon 15 if it occurs at a specific point in time, for example on a specific day. Various types of icon 15 can be used depending upon the nature of the event, for example deadlines have one icon 15a and meetings have another icon 15b.

Each event which extends over a period of time is indicated by a bar 16 extending between the start and end dates of the event. Various styles of indicator bar 16 can be used depending upon the nature of the event, for example in February a project has one style of bar 16a and exam preparation has another 16b. There may be several styles of indicator bar 16 for each type of event to ensure that adjacent events of the same type can be distinguished. Events occurring at a point in time close to the given point in time 14 are also accorded labels to identify the event. The project shown by bar 16a is provided with label 17a and the exam preparation shown by bar 16b is provided with label 17b.

It will be readily understood that the timeline 1 thus allows detailed information to be displayed for impending events while still allowing an overview of all upcoming events over a large period of time.

FIG. 5 shows a timeline 1 substantially identical to that of FIG. 4 though the labels 17a, 17b are omitted. Where it is desired to display a timeline representing the time period around a particular date (instead of displaying the time period as starting from a particular date), an indicator representing the position on the timeline of such a reference date (i.e. the given point in time 14) may be useful. Such an indicator 14a is shown in this Figure. The given point in time 14 occurs part-way through the first interval 2 and thus the timeline 1 displays events occurring both before and after the given date 14. However, the apparatus though is arranged in such a way that the timeline 1 starts with the interval representation containing the given point in time and thus when the given point of time moves into the second interval representation 3, this second interval representation 3 will become the new first interval representation and the old first interval representation 2 will no longer be displayed. Thus the timeline 1 always has substantially the same format and displays relevant information.

Also indicated in FIG. 5 are the temporal points A, B at which the display area accorded to each interval representation is reduced.

Point A occurs between the second and third interval representations 3, 4 and the interval representations 4, 5, 6, 7, 8, 9, 10, 11, 12, 13 after point A each have a smaller display area than those before. Point B occurs between the fifth and sixth interval representations 6, 7 and the interval representations 7, 8, 9, 10, 11, 12, 13 after point B each have a smaller display area than those before.

Points A and B can both be chosen by a user. Alternatively points A and B can be automatically selected. Points A and B can be calculated on the basis of the temporal distance from the given point in time 14. Alternatively/additionally, they may be calculated to lie at points in time such that a set number or percentage of events lie before and/or after each point.

It will be appreciated that various different apparatus may implement the invention. In one variant of the apparatus, a timeline generator may generate a new graphical representation of a timeline at any point on an existing timeline designated by the user (for instance, by pressure on a stylus). This may allow quick and intuitive scrolling through a timeline. In another variant, the timeline generator may adjust graphical representations of the screen so that reference points (i.e. the given point in time) may be changed in an intuitive manner to allow close inspection of a timeline around the given point. In this way, more detail may be provided for months immediately preceding and following the newly designated given point in time.

Although the time periods shown in the Figures are months, it will be appreciated that this is just one example and that the invention is not limited to representations of any particular time periods.

It will be appreciated that various alternative embodiments of timeline 1 are possible. For instance, the timeline may not necessarily commence at the given point in time 14, but may also feature interval representations preceding the given point in time. In such a case, the timeline 1 may be arranged in such a way that those interval representations occurring before the given point in time are accorded a smaller display area than the interval representations containing the given point in time 14. The timeline 1 may thus be able to give an overview of past events which can be useful in project planning.

It will be understood that the apparatus 100 may be further/alternatively provided with different types of input devices than those shown. For instance, the apparatus may include a scroll wheel, arrow buttons and the like to navigate along the timeline. Manipulation of buttons or the wheel may change a position of the given point in time in accordance with a designated direction.

It will also be appreciated that, where appropriate, functions described as being carried out by software modules may be replaced by dedicated hardware modules, and vice versa.

It will also be understood by those skilled in the art that the apparatus and method described herein may be embodied within or form part of a program arranged to run on a PDA, palmtop, laptop or any other suitable electronic apparatus.

An apparatus displaying a timeline as described herein is thus able to provide a user with detailed information relating to impending events while also giving an overview of distant events and making optimum use of available display space.

1. A timeline display apparatus comprising a processor (240), a memory (250), a graphics engine (230), and a display (120) arranged to generate and display a timeline (1) on which events can be displayed, wherein the timeline generated is divided into a plurality of interval representations corresponding to temporal intervals (2, 3, 4, 5, 6, 7, 8, 9, 10, 11, 12, 13) characterized in that the display area allocated to at lease one interval representation (2, 3, 4, 5, 6, 7, 8, 9, 10, 11, 12, 13) is dependent upon the temporal distance of that particular interval representation from a given point in time (14).

2. The apparatus as claimed in claim 1, wherein the given point in time (14) is the earliest moment in time on the timeline (1).

3. The apparatus as claimed in claim 1, wherein each interval representation (2, 3, 4, 5, 6, 7, 8, 9, 10, 11, 12, 13) corresponds to a regular and fixed time interval irrespective of the display area allocated to it.

4. The apparatus as claimed in claim 1, wherein the timeline (1) is arranged in such a way that the interval representation (2) containing the given point in time is accorded a display area which is equal to or larger than the display area accorded to an interval representation immediately succeeding it.

5. The apparatus as claimed in claim 1 wherein the given point in time (14) corresponds to the point in time at which the timeline (1) is being displayed.

6. The apparatus as claimed in claim 1, wherein at least one interval representation (3) which succeeds or precedes the interval representation containing the given point in time (14) is accorded a substantially smaller display area dependent upon the temporal distance from the given point in time (14).

7. The apparatus as claimed in claim 6, wherein the further away an interval representation is from the given point in time (14), the smaller the display area allocated to it.

8. The apparatus as claimed in claim 3, wherein a number of interval representations adjacent to the interval representation containing the given point in time (14) can be selected to have an identical amount of display area allocated to each of them, after which the display area accorded to less adjacent interval representations of the same type is reduced.

9. The apparatus as claimed in claim 8, wherein a user may select the point at which the display area allocated to interval representations is reduced.

10. The apparatus as claimed in claim 8, wherein the processor (240) is arranged to automatically select a point at which the display area allocated to a particular type of interval representation is to be reduced.

11. The apparatus as claimed in claim 10, wherein a number of events occurring within each temporal interval designated by the respective interval representations (2, 3, 4, 5, 6, 7, 8, 9, 10, 11, 12, 13) is counted and the relative number of events needing to be represented within each given interval representation is taken into account so as to determine the temporal distance from the given point in time (14) at which to impose smaller display areas upon interval representations.

12. The apparatus as claimed in claim 1, wherein an event occurring at a specific point in time is indicated on the timeline (1) by an icon (15).

13. The apparatus as claimed in claim 1, wherein an event extending between two points in time can be indicated on the timeline (1) by a bar (16) extending between the start and end points on the timeline (1) corresponding to the start and end of the event.

14. The apparatus as claimed in claim 1, wherein events falling within a time internal having the largest amount of display area allocated to it (14) can be labelled with textual information (17a, 17b) to indicate details of the event.

15. The apparatus as claimed in claim 1, wherein there are provided a plurality of types of interval representation, each type corresponding to a fixed temporal interval such as a month, a week or a day.

16. A computer program product (140) for creating a timeline (1) for a timeline display apparatus, wherein the product is arranged to generate a timeline for display on the apparatus and to divide the timeline into a plurality of interval representations corresponding to temporal intervals (2, 3, 4, 5, 6, 7, 8, 9, 10, 11, 12, 13), and upon which timeline events can be displayed, the product being characterized in that the display area accorded to at least one interval representation (2, 3, 4, 5, 6, 7, 8, 9, 10, 11, 12, 13) is dependent upon its temporal distance from a given point in time (14).

17. A method of displaying temporal information, the method comprising the step of programming an apparatus to display a timeline (1) divided into a plurality of interval representations corresponding to temporal intervals (2, 3, 4, 5, 6, 7, 8, 9, 10, 11, 12, 13), characterized in that the apparatus is programmed such that the display area accorded to at least one interval representation (2, 3, 4, 5, 6, 7, 8, 9, 10, 11, 12, 13) is dependent upon its temporal distance from a given point in time (14).
